(19) United States
(12) Patent Application Publication
(10) Pub. No.: US 2015/0037230 A1
(43) Pub. Date: Feb. 5, 2015

(54) SIMPLE LOW ENERGY PROCESS FOR THE SEPARATION OF ZINC AND COPPER FROM AN AMMONIACAL SOLUTION

(71) Applicant: Peninsula Copper Industries, Inc., Hubbell, MI (US)

(72) Inventor: Louis Pignotti, Novi, MI (US)

(21) Appl. No.: 13/955,826

(22) Filed: Jul. 31, 2013

(51) Int. Cl. C01G 9/00; C01G 3/00

(52) U.S. Cl. CPC C01G 9/006; C01G 3/006
USPC 423/43; 423/419.1

(57) ABSTRACT

A method for selectively precipitating basic zinc carbonates (BZC) from basic copper carbonates (BCC) from an aqueous ammoniacal solution prepared using a mixture of copper- and zinc-containing materials.

### BACKGROUND OF THE INVENTION

Basic Zinc Carbonate (BZC) and Basic Copper Carbonate (BCC) are well known chemicals which have a variety of uses including, without limitation, in biocides, pigments, catalysts, and nutritional supplements. They are also important intermediates for the production of the zinc oxide and copper oxide, respectively, which have similar end applications. BZC and BCC are general descriptions for a class of chemicals, which includes several different compounds with discrete formulations.

BZC comprises three compounds, two of which are minerals: smithsonite, which has the formula ZnCO₃, and hydrozincite, which has the formula Zn₅(CO₃)₂(OH)₆. The BZC family also includes the coordination compound zinc ammine carbonate having the formula ZnCO₃NH₃. BCC similarly comprises two minerals: azurite, having the formula Cu₃(CO₃)₂(OH)₂, and malachite, having the formula Cu₂CO₃(OH)₂. A summation of their compositions can be found in Table 1.

TABLE 1
Theoretical Composition of Various Types of Carbonates

| | F.W. | | | CO₃⁻²% | | |
|---|---|---|---|---|---|---|
| | (g/mol) | Zn % | Cu % | (CO2 %) | NH₃% | HO⁻ % |
| Hydrozincite | 549.0 | 59.6 | 0 | 21.9 (16.0) | 0 | 18.6 |
| Smithsonite | 125.4 | 52.1 | 0 | 47.9 (35.1) | 0 | 0 |
| Zinc ammine | 142.4 | 45.9 | 0 | 42.1 (30.9) | 12.0 | 0 |
| carbonate | | | | | | |
| Malachite | 221.1 | 0 | 57.5 | 27.1 (19.9) | 0 | 15.8 |
| Azurite | 344.7 | 0 | 55.3 | 34.8 (12.8) | 0 | 8.7 |

Various methods for the preparation of BCC are known in the art. One traditional method of making BCC may be referred to as “caustic boil.” In this method, copper metal is dissolved in an ammonia/ammonium carbonate solution via well-known techniques developed in the 1800s, followed by boiling off the ammonia to precipitate BCC. The caustic boil method is an energy-intensive process and, therefore, less desirable compared to other more efficient methods. Also, when leaching electronegative metals such as zinc, hydrogen gas will be released. Hydrogen gas is a hazard, and adds to the engineering controls required for safe operation.

Methods for separating copper and zinc from ammoniacal systems are known. One method, described in U.S. Pat. Nos. 2,805,918 and 2,839,388, teaches controlling the caustic boil method to first precipitate BZC, separating the precipitated solid from the solution, followed by precipitating BCC. However, precisely removing ammonia by heating, as required by this method, can be difficult to control. Another method of separating copper and zinc from an ammoniacal system involves using ion exchange technology, as taught in U.S. Pat. No. 3,971,652. Due to low loading capacity, large process volumes and complicated process controls are required for ion exchange technology; this increases the capital requirements for its implementation. The process described in U.S. Pat. No. 7,776,306 allows for the low energy production of BCC, but does not disclose or teach the production of BZC.

A method for preparing BZC and BCC which provides advantages over known methods would be desirable.

### BRIEF SUMMARY OF THE INVENTION

The present invention meets the foregoing and other needs by providing, in one aspect, a method of preparing basic zinc carbonate and basic copper carbonate comprising: (a) providing an aqueous solution of zinc (II), copper (II), an amine, and carbonic acid in a first reaction vessel; (b) adjusting the pH of the aqueous solution until basic zinc carbonate is formed, wherein the pH of the solution is adjusted by increasing or decreasing the carbonic acid concentration at a controlled rate; (c) recovering the basic zinc carbonate from the aqueous solution by filtration; (d) transferring the aqueous solution which remains after recovery of basic zinc carbonate in step (c) into a second vessel; (e) further adjusting the pH of the transferred aqueous solution until basic copper carbonate is formed; (f) recovering the basic copper carbonate from the transferred aqueous solution by filtration; (g) transferring the aqueous solution which remains after the recovery of basic copper carbonate in step (f) into a third vessel; (h) removing carbon dioxide from the aqueous solution which remains after the recovery of basic copper carbonate in step (f); (i) introducing a zinc metal- and copper metal-containing material into the aqueous solution which remains after the removal of carbon dioxide in step (h); (j) oxidizing the zinc metal- and copper metal-containing material to provide a replenished zinc (II) and copper (II) aqueous solution; and (k) introducing the replenished zinc (II) and copper (II) solution into the first reaction vessel.

In a related aspect, the aforesaid inventive method is desirably made continuous with the repetition of steps (b) through (k).

### BRIEF DESCRIPTION OF THE DRAWING

FIG. 1 is a schematic diagram showing an exemplary operational flow of a continuous method of preparing Basic Zinc Carbonate (BZC) and Basic Copper Carbonate (BCC) according to one aspect of the present invention.

### DETAILED DESCRIPTION OF THE INVENTION

The present invention provides a novel method for separating zinc and copper from the same solution by the sequential production of Basic Zinc Carbonate (BZC) and Basic Copper Carbonate (BCC).

The invention contemplates providing an aqueous solution comprising Zn(II), Cu(II), an amine and carbonic acid. BZC and BCC are subsequently, and sequentially, precipitated from the solution by gradually lowering the pH via the addition of CO₂, as precipitation of these carbonates occurs at different pH ranges and concentrations of solution components. In the inventive method, BZC will precipitate, and preferably substantially completely, prior to the precipitation of BCC. BZC and BCC may be separated from the solution after their precipitation in a single step or, desirably, by using two separate filtration steps.

The foregoing method may be practiced in any suitable reaction vessel or vessels, e.g., a spray chamber, a stirred tank reactor, a rotating tube reactor, or a pipeline reactor, and in either a batch, or desirably a continuous, process. Preferably, the method is practiced as a continuous process using a continuous stirred tank reactor.

The inventive method may use a variety of metal sources, including without limitation zinc, copper, brass, bronze, zinc alloys, copper alloys, copper clads, zinc and copper compounds, or mixtures of any of the foregoing materials. It is particularly advantageous to use brass as a raw material for the production of BZC and BCC because its use avoids the production of hydrogen gas. This is because oxidizers, such as oxygen gas or air, will preferentially oxidize the copper in the brass to the cuprous, and then cupric, state. Two cupric ions will then oxidize zinc to zinc (II). The resulting cuprous ions will then be re-oxidized to the cupric state, completing the leaching cyclic without decomposition of the solvent. Brass has the additional advantages of being a readily available scrap metal. Most alloys of brass have higher zinc content than galvanized steel which represents a large portion of the scrap zinc market.

In the inventive method, a metal-enriched aqueous feed stream is initially prepared. This feed stream comprises ammonia, water, carbonic acid, oxygen, and other components. Desirably, the aqueous feed stream will comprise the following components, in certain amounts: metal, comprising copper and zinc, from about 45 g/L to about 140 g/L, and preferably from about 75 g/L to about 100 g/L; water; oxygen; ammonia from about 15 g/L to about 130 g/L, and preferably from about 65 g/L to about 100 g/L, and an ammonia to metal molar ratio of from about 2.0:1 to about 4:1, and preferably from about 2.2:1 to about 3.2:1; and carbonic acid from about 10 g/L to about 170 g/L, and preferably from about 80 g/L to about 110 g/L.

The weight ratio of zinc to copper in the feed stream to the first reaction vessel may range from less than about 1:100 to more than about 100:1. In order for the inventive method to be carried out in a continuous manner, the ratio of zinc to copper in the total material precipitated should be the same as in the material used as the starting scrap. For example, and without limitation, a method in which the combined amount of metal to be precipitated in the reaction vessels is about 50 g/L and in which the feed material for the process is yellow brass (30% Zn, 70% Cu), an appropriate feed concentration for the first reaction vessel would be about 15 g/L Zn and about 85 g/L Cu. The feed solution for the second reaction vessel would be about 0 g/L Zn and about 85 g/L Cu. The solution exiting the second reactor would then be about 0 g/L Zn and about 50 g/L Cu.

Generally, as the content of the aqueous feed stream is known, one skilled in the art should be able to create a feed stream having the relative amount of each component required to practice the inventive methods.

The amine used in the inventive method may be one or more of any number of trivalent nitrogen compounds but is preferably that of aqueous solutions of ammonia. In an aqueous solution, ammonia is found in equilibrium with ammonium hydroxide. The amine in solution aids in solubilizing the metal; however an excess of ammonia will inhibit the precipitation process. Thus, a typical range of ammonia in solution may be about 15 g/L to about 130 g/L, with a more desirable range being about 65 g/L to about 100 g/L. It is best practice to generate a feed solution that is saturated with metal. This saturation occurs when the molar ratio of amine to total metal content ranges from about 2.0 to about 4, with a preferred molar ratio ranging from about 2.2 to about 3.2, and more preferred ratio ranges from about 2.3 to about 2.7. The most efficient process occurs when the molar ratio of amine to total metal content is about 2.5.

The carbonic acid useful in the inventive method includes carbonic acid as well as bicarbonate and carbonate ions. It should be appreciated by one of ordinary skill in reading this disclosure that one or more of these species may be present when CO₂ is introduced into the aqueous solution, as described further herein.

In the method, it is desirable to control the amount of carbonic acid content of the feed stream (as well as in the aqueous stream as it moves through the various method steps), as control of the amount of acid is the principle method for controlling the methodology, for example, the conversion of the material in the aqueous stream into BZC and BCC. While the acid content may be provided by any suitable means, it is desirably provided and controlled via the introduction and removal of gaseous CO₂. Preferably, gaseous CO₂ is introduced into each reaction vessel, e.g., by releasing the gas through a sparging tube at the bottom of the reactor and allowing it to bubble through the solution. In a continuous process, it is also possible to dissolve the gas into the solution upstream of the reaction vessel.

The typical amount of dissolved CO₂ in the solution feed stream may range between about 10 g/L and about 170 g/L, with a more desirable concentration ranging between about 80 g/L to about 110 g/L about. Further, the molar ratio of ammonia and carbonic acid may range from about 3.1 to about 1.0, preferably from about 1.8 to about 1.2, more preferably from about 1.6 to about 1.3, and most preferably about 1.4.

In the inventive method, the introduction and removal of the CO₂ gas also functions to adjust the pH of the aqueous solution in the various method steps in order to precipitate BZC or BCC. The pH of the solution at which each either BZC or BCC form also is influenced by the absolute values of ammonia and carbonate that are in the aqueous solution. However, irrespective of the concentration of ammonia or carbonate in the aqueous solution, when lowering the pH of the solution, zinc will preferentially precipitate from the solution prior to copper. While it was found that both BZC and BCC will form when the aqueous solution is between a pH of about 7 to about 10, BZC will more commonly form between a pH of about 9.2 to about 8.2, while BCC will form between a pH of about 8.5 to about 7.

In order to form BZC free of significant contamination of BCC, it is desirable to control the formation of carbonic acid. Relatively rapid formation of carbonic acid, with the corresponding rapid drop in pH, will undesirably cause BCC to form prior to the completion of BZC formation. It has been found, however, that by controlling the rate at which the pH is adjusted, one can selectively control the precipitation of BZC relative to BCC. One skilled in the art, upon understanding the teaching provided herein, should be able to identify the rate of gaseous CO₂ introduction so that at least about 90%, more desirably at least about 95%, and preferably at least about 98%, of the zinc present in solution will have precipitated in the form of BZC prior to the formation BCC. By way of illustration, CO₂ may be introduced into the solution at a rate of about 0.1 LPM per liter of solution to about 10 LPM per liter of solution, and more preferably at a rate of about 0.5 LPM per liter of solution to about 1.5 LPM per liter of solution, so that the concentration of carbonic acid in solution is increased at a rate of about 10-30 g hr⁻¹ per liter of solution, and more desirably at about 12 to about 16 g hr⁻¹ per liter of solution. The former rate would correspond to a precipitation rate of around 5-10 g hr⁻¹ of zinc per liter of solution. In a pressurized system where gas is also vented from the reaction vessel at a rate of about 1-1.5 L min⁻¹ per liter of solution, the total consumption of CO₂ would be about 30-45 g hr⁻¹ per liter of solution.

With the foregoing controlled rate of CO₂ consumption, the rate at which carbonic acid forms and the pH of the solution drops is also controlled. Therefore, the limits of BCC present in the reaction vessel at the completion of precipitation step (b) and/or the commencement of the recovery of BZC in step (c) is from about 0.0001 to about 2 wt. % of the solids present, desirably from about 0.0001 to about 1 wt %, more desirably from about 0.0001 to about 0.5 wt. %, and preferably from about 0.0001 to about 0.1 wt. % of the solids present.

With the inventive method outlined above, it is possible to produce BZC which contains copper in amounts from about 0.0001 to about 2 wt. %, desirably from about 0.0001 to about 1 wt %, more desirably from about 0.0001 to about 0.5 wt. %, and preferably from about 0.0001 to about 0.1 wt. %. This foregoing copper content is suitable for many industrial application; however if the final use of the material requires that copper be present in no more than trace quantities (e.g. 1 ppm, or less), it is desirable to conduct a second precipitation process. This is desirably completed by redissolving the BZC isolated after step (c) in an aqueous amine solution. This aqueous solution may then be passed a second time through the inventive method, as described herein. At these lower processing concentrations, the use of an ion exchange system or cementation with zinc powder may be used, as such becomes more economically viable.

Following precipitation and separation of the solids, it may be necessary to reduce the carbonic acid level, or increase the pH, in the solution to provide a suitable solution for metal leaching. This may be accomplished by reducing the partial pressure of CO₂ in the vessel, or nominally through a reduction of the total pressure within the reaction vessel, for example, by bringing the solution to atmospheric pressure, warming the solution, and then agitating it. Preferably the solution is passed through a packed tower. In order to leach additional metal into solution, the pH of the leaching solution should be between 9 and 10.

The inventive method may be carried out in a reaction vessel which is operated either at atmospheric pressure or at elevated pressure. Operating the inventive method under pressure causes an increase in the partial pressure of CO₂ found within the solution. This has the advantage of increasing the kinetics of the reaction. In this regard, the inventive method may be carried out at pressures up to and beyond 1000 psi, such as from about 0 psig to about 1500 psig. Preferably, the pressure in the reaction vessel ranges from about 20 psig to about 500 psig, and more preferably from about 80 psig to about 250 psig. Running the inventive process at the desired and preferred pressures provides the advantage of increased kinetics without the additional expense of ultra high pressure process equipment.

One of the advantages of the inventive method is that BZC and BCC may be obtained from metal-containing solutions using less energy relative to known methods. While the inventive methods may be carried out at any suitable temperature, e.g., from about 5° C. to the boiling point of the solution, it is desirable that a limited amount of, or desirably no, heat need be added to the solution during the formation of the basic metal carbonates. For example, the methods desirably contemplate maintaining the temperature of the solution from about 5° C. to about 100° C., more desirably from about 25° C. to about 80° C., and most desirably in the range of about 30-40° C.

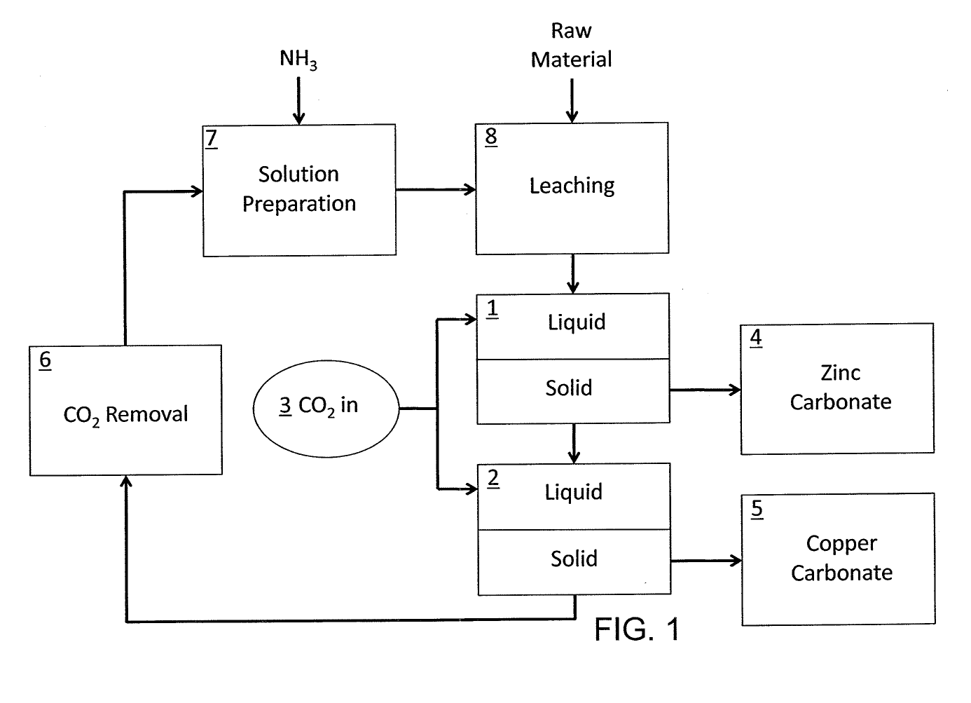

As mentioned previously, an aspect of the inventive methods desirably provides a means for the continuous preparation of BZC and BCC. FIG. 1 is a schematic diagram, which provides an exemplary operational flow of a method of providing BZC and BCC in accordance with this aspect of the invention. Referring to this FIGURE, the method includes processing stages that may be referred to as precipitations 1 and 2, filtrations 4 and 5, CO₂ addition 3, CO₂ separation 6, solution adjustment 7, and leaching 8.

Referring to the diagram, the method illustrated therein involves introducing an aqueous ammonium hydroxide-ammonium carbonate solution saturated with Zn (II) and Cu (II) into a first reaction vessel 1. At the same time that the solution is introduced into the reaction vessel, CO₂ gas is introduced 3 causing carbonic acid to form in situ. The solution leaving the reaction vessel 1 is a slurry which is composed of a white solid (BZC) and a blue supernatant liquid containing Cu (II), an amine, and carbonic acid. This solution is then filtered to yield BZC 4.

The filtration process contemplated by the invention may be performed by any suitable means, but is desirably performed under pressure (e.g., between about 1 psig and about 1500 psig) to prevent desorption of CO₂, the latter potentially causing solids to re-dissolve in the solvent solution. Further, filtration under pressure (above ambient) may prevent the solids from agglomerating at the bottom of the filter. Suitable filtration devices are those that can be kept under pressure such as a pressure plate filter or an automatic pressure filter. Filtration may also be accomplished, without exclusion, with a belt filter, pressure belt filter, drum filter and candle filter. The solid filtrate may then be rinsed to remove the remaining supernatant. The rinse may comprise a number of different solutions and, without restriction, is typically fresh water. Additionally, a small amount of dilute ammonium carbonate can be used to wash the cake, which may possess a small amount copper remaining from the supernatant.

The filtrate from the previous step, without dilution from cake wash, is introduced into a second reaction vessel 2, where additional CO₂ is introduced 3, desirably in the same manner as previously described. The solution exiting this vessel 2 is a slurry containing a blue or green solid (BCC) and a blue supernatant. This slurry is then filtered as previously described to yield BCC 5.

After filtration is completed, the metal-depleted solution from step 5 desirably may be degassed to remove excess carbonic acid 6. Carbonic acid is removed from the filtrate from the last step in order to increase the pH up into a suitable range for leaching additional metal. CO₂ removal may be accomplished by any suitable method, e.g., by boiling for a designated time in a vessel equipped with a condenser (to collect the distillate). Alternatively, or in addition, CO₂ may be removed by air stripping or pressure reduction. It is desirable to capture CO₂ from this step and then compress and recycle the CO₂ into step 3.

The degassed, metal-depleted solution then enters a preparation stage 7 where any amine lost during processing is added back into the solution. This solution is then introduced into a vessel 8 which contains the metal source as described previously. When an oxidizing agent, such as oxygen or air, is introduced, the metal will oxidize and go into solution to provide a replenished metal solution. The time required for this operation can take several hours or several days pending on the surface area of the scrap metal. Typically the solution will become saturated with Zn (II) and Cu (II) within several hours if high surface area scrap such as turnings and tubing are used. Once saturated the solution will be ready for introduction into the vessel in part 1 of the process, and utilized in the method described herein to sequentially provide BZC and BCC. As this method provides for continuous processing in a closed loop, waste production is minimized and lower energy consumption is achieved.

The exemplary continuous method illustrated in FIG. 1 is provided as one possible embodiment of the inventive method, and may be modified as desired. For example, the replenished metal solution may be diluted with water prior to its use in the method in order to restore an appropriate solution concentration. Also, after BZC or BCC is formed, and prior to filtration, the resultant slurry may be subjected to a thickening process.

The inventive method also contemplates preparing BZC and BCC by contacting zinc and copper metal with an aqueous solution comprising an amine, carbonic acid (which may be present as a carbonate, as described herein), and oxygen under conditions where the metal is converted into BZC and BCC; and recovering the BZC and BCC.

The invention further contemplates a method of forming BZC and BCC comprising the steps of providing zinc and copper compounds in an aqueous solution comprising an amine and a sufficient amount of carbonic acid.

The following examples further illustrate the invention but, of course, should not be construed as in any way limiting its scope.

### Example 1

This example demonstrates the ability to selectively precipitate BZC over BCC in an open container at atmospheric pressure.

A 4 L glass beaker was filled with 3.5 L of a solution containing 81.1 g/L NH₃, 66.2 g/L CO₂, 44.5±2% g/L Cu, and 49.8±2% g/L Zn. The solution had a pH of 11.32 and was kept at a temperature of 25° C. CO₂ was bubbled through the solution with a ¼″ O.D. stainless steel tube which was submerged 8″ into the solution. CO₂ was bubbled at the rate of 1 liter per minute. After 6 hours the solution had reached a pH of 9.12 and a solid had started to precipitate. After 7 hours the solution was filtered. At this point the solution's pH was 9.04, and the solution contained 78.3 g/L NH₃, 103.4 g/L CO₂, 45.2±2% g/L Cu and 34.5±2% g/L Zn. The resulting precipitate was washed thoroughly with water to yield a white solid. This solid was dried in a 40° C. oven to give a final yield of 87.2 g. Analysis of the solid showed the following composition: 58.1±2% % zinc and 0.1±2% % copper (determined by ICP-OES), 13.9% CO₂ (determined by differential pressure), and 0% NH₃ (determined by the Kjeldhal method). This result is consistent with the composition of hydrozincite.

### Example 2

This example demonstrates the ability to selectively precipitate BZC over BCC and then bring the reaction solution to a suitable range such that metal can be redissolved into it.

12 liters of an aqueous solution containing 81.2 g/L CO₂, 70.5 g/L NH₃, 19.8±2% g/L Zn, 58.84±2% g/L Cu, and at a pH of 9.50 were added to an airtight 14 L stainless steel continuously stirring tank reactor. CO₂ gas was bubbled through the solution via a ½″ O.D. tube which was submerged twelve inches into the solution. CO₂ was vented from the top of the reactor at a rate of 12 liters per minute. The internal pressure of the reactor was maintained at 100 psi. The initial temperature of the solution was 17.6° C. After 1 hour the pH of the solution was 8.78 and some solids had formed. After 6 hours the solution had a pH 7.82 and had warmed to 26.7° C. The solution now contained 126.37 g/L CO₂, 64.2 g/L NH₃ and 3.2±2% g/L of Zn. The concentration of Cu in solution had not statistically changed. The solution was filtered and the resulting solids were rinsed with copious amounts of water to yield a white powder. The solid was dried in a 40° C. oven, yielding a mass of 299.5 g. Analysis of the dried solid showed it had the following composition: 50.5±2% % zinc and 0.1±2% % copper (determined by ICP-OES), 27.7% CO₂ (determined by differential pressure), and 8.35% NH₃ (determined by the Kjeldhal method). This result would suggest a material primarily composed of zinc ammine carbonate.

The filtrate (without dilution) was placed back into the reactor and again put under pressure with CO₂, which was vented at the rate of 12 liters per minute. After 6 hrs, the solution had a temperature of 22.3° C. and a pH of 7.65. The solution chemistry was 134.74 g/L CO₂, 64.7 g/L NH₃, 2.6±2% g/L Zn, and 55.5±2% g/L Cu. The solution was filtered and the resulting solid was rinsed with copious amounts of water to yield a blue powder. The solid was dried in a 40° C. oven yielding a mass of 13.9 g. Analysis of the dried solid showed it had the following composition: 31.0±2% % zinc and 18.7±2% % copper (determined by ICP-OES), 28.6% CO₂ (determined by differential pressure), and 6.9% NH₃ (determined by the Kjeldhal method). The resulting powder was a pale blue with clearly identifiable white and blue crystals suggesting a mixture of BZC and BCC.

The filtrate (without dilution) was placed back into the reactor. The reactor was left open to the atmosphere and was warmed with a heating mantle. The solution was vigorously stirred. After 2 hours the solution had reached a temperature of approximately 50° C. The solution was maintained at 50° C. for an additional 4 hours. The final solution had a pH of 8.20, the CO₂ concentration was 106.6 g/L, and the ammonia concentration had not significantly changed.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A process for providing basic zinc carbonate and basic copper carbonate comprising:
(a) providing an aqueous solution of zinc (II), copper (II), an amine, and carbonic acid in a first reaction vessel;
(b) adjusting the pH of the aqueous solution until basic zinc carbonate is formed, wherein the pH of the solution is adjusted by increasing or decreasing the carbonic acid concentration at a controlled rate;
(c) recovering the basic zinc carbonate from the aqueous solution by filtration;
(d) transferring the aqueous solution which remains after recovery of basic zinc carbonate in step (c) into a second vessel;
(e) further adjusting the pH of the transferred aqueous solution until basic copper carbonate is formed; and
(f) recovering the basic copper carbonate from the transferred aqueous solution by filtration

2. The method of claim 1, further comprising the steps of:
(g) transferring the aqueous solution which remains after the recovery of basic copper carbonate in step (f) into a third vessel;
(h) removing carbon dioxide from the aqueous solution which remains after the recovery of basic copper carbonate in step (f);
(i) introducing a zinc metal- and copper metal-containing material into the aqueous solution which remains after the removal of carbon dioxide in step (h);
(j) oxidizing the zinc metal- and copper metal-containing material to provide a replenished zinc (II) and copper (II) aqueous solution; and
(k) introducing the replenished zinc (II) and copper (II) solution into the first reaction vessel.

3. The continuous method of claim 1, wherein the amine is ammonium hydroxide.

4. The continuous method of claim 1, wherein the pH is adjusted by increasing or decreasing the carbonic acid concentration.

5. The continuous method of claim 4, wherein during step (b) the rate at which the carbonic acid concentration is increased is controlled.

6. The continuous method of claim 5, wherein during step (b) the rate of carbonic acid increase is controlled by adding CO₂ gas at a rate of from about 0.1 LPM per liter of solution to about 10 LPM per liter of solution.

7. The continuous method of claim 5, wherein during step (b) the rate of carbonic acid increase is controlled by adding CO₂ gas at a rate of from about 0.5 LPM per liter of solution to about 1.5 LPM per liter of solution.

8. The continuous method of claim 1, wherein the temperature of the solution ranges from about 20° C. to about 100° C.

9. The continuous method of claim 1, wherein the temperature of the solution ranges from about 25° C. to about 80° C.

10. The continuous method of claim 1, wherein the temperature of the solution ranges from about 30° C. to about 40° C.

11. The continuous method of claim 1, wherein reaction vessel is a spray chamber, a stirred tank reactor, a rotating tube reactor, or a pipeline reactor.

12. The continuous method of claim 1, wherein step (b) is carried out at ambient pressure.

13. The continuous method of claim 1, wherein the pressure in the reaction vessel during step (b) ranges from about 0 psig to about 1500 psig.

14. The continuous method of claim 12, wherein the pressure in the reaction vessel during step (b) ranges from about 20 psig to about 500 psig.

15. The continuous method of claim 13, wherein the pressure in the reaction vessel during step (b) ranges from about 80 psig to about 250 psig.

16. The continuous method of claim 1, wherein the zinc metal- and copper metal-containing material is one or more of brass, bronze, zinc alloys, copper alloys, copper dads, or zinc and copper compounds.

17. The method of claim 1, wherein the limits of BCC present in the reaction vessel at the completion of precipitation step (b) and/or the commencement of the recovery of BZC in step (c) is from about 0.0001 to about 2 wt. % of the solids present.

18. The method of claim 16, wherein the limits of BCC present in the reaction vessel at the completion of precipitation step (b) and/or the commencement of the recovery of BZC in step (c) is from about 0.0001 to about 2 wt. % of the solids present.

19. The continuous method according to claim 1, wherein during step (b) the molar ratio of ammonia to the total amount of metal in solution in the reaction vessel ranges from about 2.5 to about 4; the temperature of the solution in the reaction vessel ranges from about 20° C. to about 80° C.; the pressure in the reaction vessel ranges from about 20 psig to about 500 psig; and the pH is adjusted by increasing the concentration of carbonic acid in the solution at a rate of about 10 g/hr per liter of solution to about 30 g/hr per liter of solution.

20. The continuous method according to claim 1, wherein during step (b) the molar ratio of ammonia to the total amount of metal in solution in the reaction vessel ranges from about 2.5 to about 3.2; the temperature of the solution in the reaction vessel ranges from about 20° C. to about 80° C.; and the pressure in the reaction vessel ranges from about 80 psig to about 250 psig; and the pH is adjusted by increasing the concentration of carbonic acid in the solution at a rate of about 12 g/hr per liter of solution to about 16 g/hr per liter of solution.

21. The continuous method according to claim 1, wherein during step (b) the molar ratio of ammonia to the total amount of metal in solution in the reaction vessel ranges from about 2.5 to about 4; the temperature of the solution in the reaction vessel ranges from about 20° C. to about 80° C.; the pressure in the reaction vessel ranges from about 20 psig to about 500 psig; and the pH is adjusted by increasing the concentration of carbonic acid in the solution by adding CO₂ gas at a rate of from about 0.1 LPM per liter of solution to about 10 LPM per liter of solution.

22. The continuous method according to claim 1, wherein during step (b) the molar ratio of ammonia to the total amount of metal in solution in the reaction vessel ranges from about 2.5 to about 3.2; the temperature of the solution in the reaction vessel ranges from about 20° C. to about 80° C.; and the pressure in the reaction vessel ranges from about 80 psig to about 250 psig; and the pH is adjusted by increasing the concentration of carbonic acid in the solution by adding CO₂ gas at a rate of from about 0.5 LPM per liter of solution to about 1.5 LPM per liter of solution.

23. The continuous method according to claim 1, wherein the basic zinc carbonate is selected from the group consisting of hydrozincite, smithsinite, zinc ammine carbonate and mixtures thereof.

24. The continuous method according to claim 1, wherein the basic copper carbonate is selected from the group consisting of azurite, malachite and mixtures thereof.

25. The method according to claim 2, further comprising the step of introducing carbon dioxide removed in step (h) into the reaction vessel.

26. The method according to claim 2, wherein transfer step (g) occurs prior to the removal of carbon dioxide step (h).

27. A continuous method for the preparation of BZC and BCC comprising:
(a) providing an aqueous solution of zinc (II), copper (II), an amine, and carbonic acid in a first reaction vessel;
(b) adjusting the pH of the aqueous solution until basic zinc carbonate is formed, wherein the pH of the solution is adjusted by increasing or decreasing the carbonic acid concentration at a controlled rate;
(c) recovering the basic zinc carbonate from the aqueous solution by filtration;
(d) transferring the aqueous solution which remains after recovery of basic zinc carbonate in step (c) into a second vessel;
(e) further adjusting the pH of the transferred aqueous solution until basic copper carbonate is formed;
(f) recovering the basic copper carbonate from the transferred aqueous solution by filtration;
(g) transferring the aqueous solution which remains after the recovery of basic copper carbonate in step (f) into a third vessel;
(h) removing carbon dioxide from the aqueous solution which remains after the recovery of basic copper carbonate in step (f);
(i) introducing a zinc metal- and copper metal-containing material into the aqueous solution which remains after the removal of carbon dioxide in step (h);
(j) oxidizing the zinc metal- and copper metal-containing material to provide a replenished zinc (II) and copper (II) aqueous solution;
(k) introducing the replenished zinc (II) and copper (II) solution into the first reaction vessel; and
(l) repeating steps (b) through (k) at least once.
